(19) United States
(12) Patent Application Publication
(10) Pub. No.: US 2003/0036960 A1
(43) Pub. Date: Feb. 20, 2003

(54) Email transmitting method using computer interactive communication network and communication system thereof

(76) Inventors: Ken Suzaki, Tokyo (JP); Kazuhiro Hayashi, Kawasaki-shi (JP)

Correspondence Address: Kanesaka & Takeuchi, 1423 Powhatan Street Suite 2, Alexandria, VA, 22314, US

(21) Appl. No.: 10/221,448

(22) PCT Filed: Nov. 9, 2001
(86) PCT No.: PCT/JP01/09809

(30) Foreign Application Priority Data
Nov. 14, 2000 (JP) 2000-347265

(51) Int. Cl. G06F 17/60; G06F 15/173

(52) U.S. Cl. 705/14; 709/224

(57) ABSTRACT

An effective direct marketing method using a computer interactive communication network is provided.

According to the present invention, an information transmitting site (information transmitting site communication system 4) repeatedly collects static attribute information upon subscription to a member (mobile phone 3 and a small general-purpose computer 6), dynamic attribute information based on answers of a questionnaire, and information, of each member, on the purchase of a commercial product in a virtual mall (virtual mall network Vsn), updates or adds the collected information, and stores it. Email information is transmitted to the members, who are ranked based on the amount of the stored information, having the largest amount of the static attribute information and the dynamic attribute information. Member's response information to the transmission is extracted. Further, the member having the static attribute information and the dynamic attribute information which match the response information is extracted and the emails are transmitted to the extracted members. The members having information that rightly matches specific contents are narrowed down and selected by transmitting the email information at least twice.

### TECHNICAL FIELD

The present invention relates to an email transmitting method, using a computer interactive communication network, for directing marketing via transmission of emails by repeatedly obtaining and managing attribute information of a marketing target (if necessary, referred to as a member) via computer interactive communication networks (such as intranet, Internet, extranet, and wide UNIX workstation, hereinafter, typically referred to as the Internet) under communication environments such as TCP/IP (Transmission Control Protocol/Internet Protocol), and relates to a communication system of the email transmitting method.

### BACKGROUND ART

In recent years, in place of direct mail by post and out-of-bounds call for directly calling members, there are a large number of direct mail advertisements and service guides (such as an email magazine) via emails on the Internet.

When announcement is performed via the emails, one company sends the emails by buying a list of a membership organization of the company and user lists, which are possessed by commercial providers and other companies (e.g., a department store and a credit card company), or by requesting the transmission of emails.

Since the emails can be sent with low costs, the same message can be transmitted to all members at once. However, much information in which the members are not interested is sent and, therefore, the members read no sent emails and follow the necessary procedures for the stop of receiving the emails of the company. The companies lose chances to get useful information. Thus, in the case of the direct mail via the email, a predetermined number of email addresses are extracted, for instance, 10,000 email addresses are extracted and the direct mails are sent to the extracted members.

The above-mentioned user members are registered to the database of the commercial providers or company's databases, and are segmented based on the attribute information thereof by using a relational database. For example, the user members are segmented based on sex, an area, an age, and so on, and the direct mails matching the attribute information are sent.

Such attribute information uses private attribute information such as address, a name, an age, and an email address. Recently, for purpose of the improvement in efficiency, there is devised and put into practical use an opt-in email system in which the member must input social attribute information such as a status in a company and a license and individual (preference) attribute information such as favorite brand name products and a favorite season, upon starting the use and the input information is utilized.

It is relatively easy to obtain the private attribute information and the social attribute information from information described on an application form upon member registration and the issue of a credit card. However, there is a variety of individual/social attribute information and, because of the following conditions, it is excessively difficult to collect information from the members with high quality in a long term, maintain the high quality, and effectively extract the information based on the content, of the described information at a questionnaire level. That is,

a) If there is too much information which is first inputted, the load of operation for inputting the member's information is increased and thus, accurate information cannot easily be collected.

b) On the other hand, if there is little information, information cannot sufficiently be obtained and cannot efficiently be extracted.

c) Since the individual/social attribute information tends to have greatly mental and impulsive aspects, it is difficult to accurately extract the information because answers are varied depending on questions.

d) Preference or the like changes in accordance with the passing of time and the change in environment. However, in association therewith, the information cannot be updated (a person who is interested in house information buys a house and, then, he is not interested in the house information).

The time-oriented change is caused in the contents of the private/individual/social attribute information. For example, the address, the status in the company, and favorite brand name product are changed depending on the age and the activity during the age. The above-changed attribute information is properly referred to as dynamic attribute information.

Many conventionally direct mailing methods use a direct mailing method, in which member's attribute information is roughly segmented and to which marketer's experience and sense are greatly contributed. As a consequence, the contents of the direct mail do not necessarily exactly match an expectation of responses to the direct mail. For instance, in the case of sending a guidance of illumination equipment for a newly-built house, a marketer might send emails to many 40s males who are expected to buy a newly-built house with high frequency. However, actually, a female group having characteristics different from those of the 40s males might greatly respond to the direct mail. Therefore, there are various proposals for improving the efficiency of the direct mail.

As disclosed in Japanese Unexamined Patent Application Publication 10-247937, there is a direct email transmitted destination selecting method as an example of a conventional art. The conventional art relates to an Internet access service operation system comprising a user information management apparatus for presenting a discounting direct email service, in which an account charge or the user is discounted, and for storing user's profile information and available information such as user's Internet access history information and purchase information a user receives a direct email, thereby providing a discount direct email service in which an account of the user is discounted. In the conventional art, a method for selecting the number of transmitting emails in response to the request for a direct mail is disclosed.

Features in the conventional art are to extract a sending condition of a direct email and a desired number of the transmitted direct emails, which are presented by a requesting side of the transmission of the direct email, the user's profile information, and the number of users having profile information which satisfies the sending condition and, thus, to select the number of transmission destinations

In recent years, the efficiency of the direct mailing using the email is increased in the above-mentioned manner.

### DISCLOSURE OF INVENTION

However, the conventional arts have the following disadvantages.

(1) In the former conventional art, direct mails are sent to the members having tile attribute information which is roughly segmented and, therefore, the efficiency of marketing is low.

(2) In the latter conventional art disclosed in the patent publication, the number of users having profile information which satisfies the transmitting condition can be extracted and the number of transmitting destinations can be selected. However, it is impossible to sequentially narrow down the users having information contents which match the attribute information and to select the user (member) having information which just matches the information contents of direct mailing.

(3) In both the former and latter conventional arts, it is impossible to obtain the latest user's attribute information which dynamically changes and to send the direct mail which rightly matches the user's attribute information, based on the management of the obtained attribute information. As a consequence, the high-level direct marketing cannot efficiently be performed with saved labor.

The user's attribute information, which dynamically changes, includes an action (preference/unpreference of a new commodity such as an automobile or food) when the user browses a shop and a commodity or buys the commodity in an Internet virtual mall. It is impossible to obtain and manage the attribute information (private/social/private attribute information) every member based on the action information and to sent the direct mail having the best matching contents for each member.

To solve the problems in the conventional arts, it is an object of the present invention to provide a direct marketing method using a computer interactive communication network and a communication system thereof, in which a direct mail can be sent only to respective targets (members) having information which rightly match an object of a company having desired contents of advertisement by repeatedly obtaining and managing attribute information of the members, etc., by using a computer interactive communication network (particularly, the Internet) under a communication environment such as the TCP/IP and high-level direct marketing can efficiently be executed with saved labor.

To accomplish the problems, according to the present invention, there is provided a An email transmitting method using a computer interactive communication network, for direct marketing research by obtaining and managing attribute information, comprising the steps of repeatedly collecting static attribute information, of members, including an email address; repeatedly collecting dynamic attribute information including individual information of the member; updating or adding the member's static attribute information and dynamic attribute information which are repeatedly collected; evaluating a correlation among information to be presented to the member and the stored static attribute information and dynamic attribute information; and extracting the member having the high correlation evaluated.

When the email information is transmitted, a function for updating or adding the dynamic attribute information by setting a response to contents of the email received to the member, to be new dynamic attribute information is provided. Further, when the email information is transmitted, the email transmitting method comprises the steps of: when the email information is transmitted, ranking the stored static attribute information and dynamic attribute information of the member based on the amount of the stored static and dynamic attribute information; transmitting the email information to the member having the maximum amount of the static attribute information and the dynamic attribute information which are ranked based on the amount of the stored static and dynamic attribute information; transmitting the email information by extracting response information to the transmission of the email information, from the member, and further extracting the member having the static attribute information and the dynamic attribute information which match the response information; and narrowing down and selecting the member having information that matches the email information having specific contents by transmitting the email information at least twice.

When the email is transmitted, the email information is transmitted, at first time, to the member having the largest amount of the static attribute information and the dynamic attribute information, and the email information is transmitted, at second time, to the member having the second largest amount of the static attribute information and the dynamic attribute information or the email information is transmitted, at second time or subsequent time thereto, to the member having the sequentially reduced number of the static attribute information and the dynamic attribute information.

According to the present invention, a point for discount when purchasing a commercial product in a virtual mall or at a general shop and/or a point for offering a coupon is added to the members upon the subscription to the member, and is allowed to be used, data on the addition and use of the point for coupon is collected, and the collected data is new dynamic attribute information, and the dynamic attribute information is updated or added.

Further, the dynamic attribute information is at least one of: (a) answer information including preference of the commercial product when a questionnaire is executed to the members; (b) purchase information of each member, including selection of the commercial product in the virtual mall; (c) delivery instruction information of each member, including delivery time of a purchased commercial product in the virtual mall; (d) payment information of each member, including payment, via net bank, of the commercial product purchased in the virtual mall; and (e) action information of each member, including the number, the time, and the frequency of clicking a specific link or banner on a related web site.

Furthermore, a direct marketing communication system comprises: member communication means which inputs and transfers static attribute information of each member, including an email address, transfers an answer to a questionnaire, and executes communication for purchasing a commercial product in a virtual mall; virtual mall communication means which executes communication for transferring information on purchase of the commercial product and information on the use of additional services such as a reward card through adding points, when the commercial product is purchase by the member communication means in the virtual mall; and email transmitting communication means which executes communication for repeatedly collecting the static attribute information from the member communication means, dynamic attribute information on the answer to the questionnaire, and information of each member, on the purchase of the commercial product, from the virtual mall communication means, updating or adding them, and storing them, for ranking the members in accordance with the amount of the stored information and transmitting email information to the member having the largest amount of the static attribute information and the dynamic attribute information which are ranked, for extracting response information from the member, further extracting the member having the static attribute information and the dynamic attribute information which match the response information, and transmitting the email information to the extracted members, and for narrowing down and selecting the members having information which rightly matches the email information with specific contents by transmitting the email information at least twice.

The computer communication means comprises: a mobile phone to which an application for interactive communication is implemented, or a mobile phone to which the application is not implemented and a small general-purpose computer to which the application connected to the mobile phone is implemented.

### BRIEF DESCRIPTION OF THE DRAWINGS

FIG. 1 is a block diagram showing the structure according to an embodiment of the present invention;

FIG. 2 is a block diagram showing the structure of a virtual mall network in FIG. 1;

FIG. 3 is a block diagram showing an example of the structure of main portions in systems in FIG. 1;

FIG. 4 is a diagram for explaining one business method in the case of embodying email transmission/direct marketing in accordance with the attribute information in the present invention;

FIG. 5 is a diagram for explaining another business method in the case of embodying the email transmission/direct marketing in accordance with the attribute information in the present invention;

FIG. 6 is a diagram showing a processing sequence in an information transmitting site communication system according to the embodiment of the present invention;

FIG. 7 is a diagram for explaining ranking member's attribute information according to the embodiment;

FIG. 8 is a diagram for explaining a specific method for transmitting an email according to the embodiment;

FIG. 9 is a diagram showing a display screen in the case of collecting dynamic attribute information through a procedure of subscription to a member via the Internet;

FIG. 10 is a diagram showing a display screen in the case of collecting the dynamic attribute information through questionnaires to members on an information transmitting site according to the embodiment;

FIG. 11 is a diagram showing a display screen in the case of collecting the dynamic attribute information when a commercial product is purchased in a virtual mall according to the embodiment; and

FIG. 12 is a diagram showing a display screen in the case of collecting dynamic attribute information through a banner advertisement with quiz on the information transmitting site according to the embodiment.

### BEST MODE FOR CARRYING OUT THE INVENTION

Hereinbelow, a detailed description is given of an email transmitting method, using computer interactive communication network, and a communication system thereof, according to an embodiment of the present invention with reference to tile drawings.

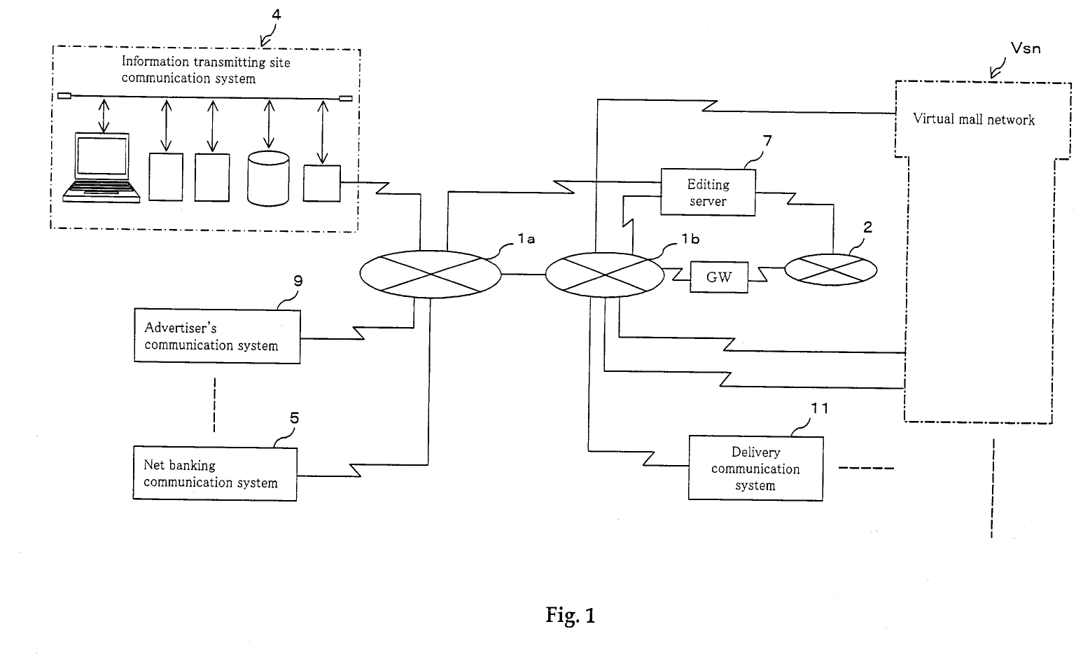

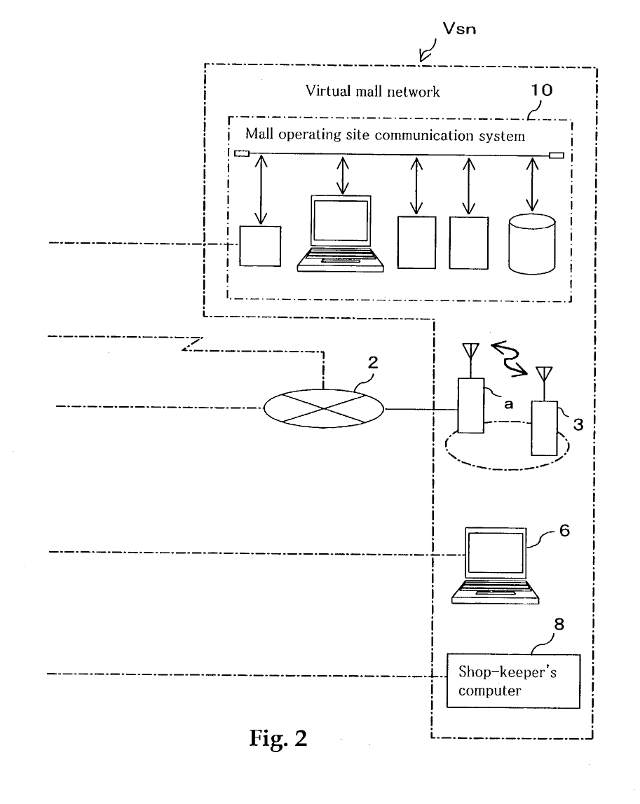

FIG. 1 is a block diagram showing the structure according to the embodiment of the present invention, and FIG. 2 is a block diagram showing a virtual mall network Vsn shown in FIG. 1.

In the virtual mall network Vsn, private/social attribute information is obtained from applications for purchasing a commercial product in the virtual mall, and individual attribute information on the browse of a shop or a commercial product and the action to purchase the product in a virtual mall (for example, preference/unpreference of a new product of an automobile or food) is obtained.

Incidentally, the private/social/individual attribute information is obtained by using other methods, for example, via described information upon application of the credit card, questionnaires in town, and the conduct of interview (questionnaires) after the subscription to the member.

Referring to FIGS. 1 and 2, according to the embodiment, the structure of a communication network (the Internet) under a TCP/IP environment is shown.

The Internet comprises a digital fixed communication network 1 (1a, 1b) serving as an ISDN (Integrated Services Digital Network). Further, the Internet comprises a digital mobile communication network 2 connected to the digital fixed communication network 1 via a gateway device GW for communication protocol conversion.

The digital mobile communication network 2 is based on a PDC (Private Digital Cellular Telecommunication System) method and a PHS (Private Handyphone System) method, and comprises a cell base station 2a. The cell base station 2a contains a large number of a mobile phones 3 (corresponding to member communication means in claims) using the virtual mall and having a web browser capable of Internet surfing, for enjoying coupon point to offer services issued, at radio intervals (via an air interface).

An information transmitting site communication system 4 corresponding to information transmitting site communication means in claims), which will be described in detail later, is connected to the digital fixed communication system 1.

The information transmitting communication system 4 comprises an inter-working device and a database device which are provided by an Internet service provider (ISP: Internet Service Provider) or a server device which is arranged independently on the ISP on the network. In this case, a used device is selected in consideration of an operation size. In the case of a large-sized operation, preferably, an operation using the server device, which facilitates an operation of a large amount of files and the maintenance, is performed.

Further, the digital fixed communication network 1 comprises a net banking communication system 5 (corresponding to net banking communication means in claims) which is provided for a net banking company for various payment of s sales total and the like in “the email transmission/direct marketing research in accordance with attribute information in the present invention”.

Incidentally, a phrase of “the email transmission/directing marketing research in accordance with attribute information in the present invention” means the following.

That is, the latest member's dynamic attribute information is obtained and managed, and the direct email having the contents which rightly match the attribute information of a sending target member (private/social/individual attribute) can be sent. Consequently, high-level direct marketing can efficiently be performed with saved labor.

Connected to the digital fixed communication network 1, are a large number of small general-purpose computers 6 (corresponding to member communication means in claims), shown in FIG. 2, for executing the Internet surfing of receiving the product sales and coupon points in the virtual mall in “email transmission/direction marketing research in accordance with the attribute information in the present invention”, and of the exchange on the Internet web site, etc.

Further, an editing server 7 is arranged between the digital fixed communication network 1 and the digital mobile communication network 2, to edit information (contents) provided by the information transmitting site communication system 4 so that it matches a small display screen of the mobile phone 3.

In addition, connected to the digital fixed communication network 1 is an advertiser communication system 9 arranged to a company or the like, which presents a banner advertisement in the virtual mall network Vsn and the information transmitting site communication system 4 together with a shop-keeper's computer 8 arranged to a company having a virtual shop and plans and embodies the direct marketing by obtaining the member attribute information collected by the information transmitting site communication system 4.

Connected to the digital fixed communication network 1 is a delivery communication system 11, arranged to a delivery company which contracts the delivery of a commercial product on an open market via the Internet and also a mall operating site communication system 10 for selling commercial products and implementing coupon point offering services in the virtual mall on the Internet.

The digital fixed communication network 1 is an IP network using the ISDN, of which the structure and transfer method are well-known, and is a network on which a packet switching station or the like is arranged to a line network. Incidentally, the digital fixed communication network 1 may be an analog telephone network PSTN (Public Switched Telephone Network).

For example, a PDC (Personal Digital Cellular) system or a PHS (Personal Handy Phone) system that conforms to the RCR STD-27 or the RCR STD-28 formulated by ARIB (Association of Radio Industries and Business of Japan) is applied to the digital mobile communication network 2. The digital mobile communication network 2 is a well-known mobile line network in which a mobile communication control station (MCC) (not shown) contains a cell base station 2a.

FIG. 3 is a block diagram showing an example of the structure of main portions in the information transmitting site communication system 4, the net banking communication system 5, and the mall operating site communication system 10.

Referring to FIGS. 1 to 3, the systems on this example is structured by a local area network (LAN) such as a UNIX workstation or Ethernet under the TCP. In the LAN system, a connecting device 13 for connection to the ISDN (digital fixed communication network 1) is provided. The connecting device 13 is a rooter or the like (not shown), on which a digital terminating connecting device (DSU) is mounted or a firewall application for preventing intrusion is implemented.

Moreover, the LAN system comprises a web server 14, as a host computer, for basic communication processing on the Internet. In addition, the LAN system comprises a database device 15 for storing and searching various data concerning the implementation of “email transmission/direct marketing research in accordance with attribute information in the present invention”. In addition, the LAN system comprises a drive device 16 for reading, from a CD-ROM, programs to execute “email transmission/direct marketing research in accordance with attribute information in the present invention” and for installing the read programs to the web server 14.

In addition, the LAN system comprises an FTP (File Transfer Protocol) server 17 for FTP file transfer and a DNS (Domain Name System) server 18 for DNS. In addition, the LAN system comprises an SSL (Secure Sockets Layer) server 19 for an encryption communication protocol, which executes payment in “email transmission/direct marketing research in accordance with attribute information in the present invention” through a debit card, a credit card, or an c-cash and is used in the case of transferring other personal information.

The LAN system comprises a small general-purpose computer 20 for maintenance of database management or the like and an interface (I/F) circuit 21.

The above-mentioned LAN system is well-known as a structure having a LAN server for executing a LAN sequence, an I/F circuit for connection via an interface, an inter-working function (IWF) server, and the like. Also, it is well-known as a structure having an firewall application for preventing the intrusion which is implemented to the web server 14, a server dedicated for implementing the firewall application, an email server, and a facsimile (Fax) server.

The IWF server is functionally integrated in the web server. Further, the IWF server executes processing of various servers including the web server. The IWF server may adopt the IWF server having above-mentioned structure in consideration of a transfer capacity (the amount of traffic) and the amount of processed data.

In other words, the information transmitting site communication system 4, the net banking communication system 5, and the mall operating site communication system 10 can be structured corresponding to various arrangement on the network. They may be structured in accordance with a processing scale. For instance, the LAN system in FIG. 3 can comprise only a single small general-purpose computer and is not limited to the structure shown in FIG. 3.

The small general-purpose computer 6 in FIG. 1 is well-known as a lower-type personal computer and a notebook-type personal computer. The small general-purpose computer 6 can have a well-known structure having, for example, a connecting device, a microcomputer, a flash memory, a drive device for information recording medium, a monitor device, an input device, a hard disk device, etc.

The mobile phone 3 in FIG. 1 is well-known as a PDC system phone or a PHS system phone. The mobile phone 3 can have a well-known structure having, for example, a frequency switching synthesizer, a transceiver radio unit including a received signal strength indicator (RSSI) detecting unit, a modulation and demodulation/time-division multiplexing unit, a codec (coding and encoding) unit, a microprocessor, an interface (I/F) unit, a memory, a key pad, a display unit such as incoming display light emitting diode (LED), a microphone for telephone transmitter, a speaker for telephone receiver, etc.

The following shows the structure of a hardware.

Next, an operation will be described according to the present embodiment.

First, a description is given of transfer formats of the digital fixed communication network 1 (1a, 1b) and the digital mobile communication network 2 in the structure of the hardware in FIGS. 1 and 2.

An IP packet is transferred at transfer speeds of 64,384 kbit/s and 1.5 Mbit/s between the digital fixed communication network 1 and each device. At the transfer speed of 64 kbit/s, 2B +D (<32 kbps×2>in an information channel+<16 kbps>in a control channel) is executed in accordance with a packet switching sequence X.31 (I.430/I.431, Q.921/Q.931, X.25 protocol) based on the ITU-T recommendation. Incidentally, another fast transfer system (e.g., asymmetric digital transfer) may be applied. Alternatively, a fast communication system (e.g., gigabit fast data communication system) may be applied.

The devices in FIG. 1 execute a communication connecting process under the well-known TCP-IP as the Internet communication, a language processing function (text, voice, and a JPEG still image or MPEG moving image process) using an HTML (HyperText Markup Language), transfer interactive communication using a hyper link function based on an HTTP (Hypertext Transport Protocol), file transfer based on the FTP, and an external application via a CGI (Common Gateway Interface). The devices include a web browser (application) for email communication and the Internet surfing for the above-described processes.

Based on data which is read by a database engine in the database device, data transmitted in a CDF (Channel Definition Format corresponding to a push-type information distribution format) of XML (Extensible Markup Language) or data transmitted in a push-pull type information distribution format is generated and a dynamic homepage is created by using ASP (Active Server Pages).

Super fine image data is generated and processed in TIFF (Tagged Image File Format) for storing a bitmap image file in the case of processing data of a photograph (catalog) of a commercial product and in PDF (Portable Document Format) file capable of converting data while keeping an image state upon creating, irrespective of a machine type and a used font.

The above-stated devices transfer files in the well-known IP packet via interactive communication under TCP/IP link. A transfer process on the Internet is executed by an object instruction in HTTP (instruction through a radio button, an anchor, a push button, etc., by using a coordinate input device such as click/mouse operation). In this case, a finish description character (FIN) of the open TCP connection and an acknowledgement character (ACK) are stored in a file format, and the file transfer is executed by identifying the stored characters.

The information transmitting site communication system 4, the net banking communication system 5, and the mall operating site communication system 10 in FIGS. 1 and 2 implement a sequence for embodying “email transmission/direct marketing research in accordance with attribute information in the present invention” via tile web server or a LAN server (not shown).

In the small general-purpose computer and the LAN system shown in FIGS. 1 and 2, “email transmission/direct marketing research in accordance with attribute information in the present invention” is embodied by communication protocols or programs which are implemented by a CPU (including a CPU of the web server). Not only the above-mentioned general-purpose communication protocols or the programs but also the communication protocols or the programs dedicated for embodying “email transmission/direct marketing research in accordance with attribute information in the present invention” are combined and implemented in the devices.

Further, the digital mobile communication network 2 and the mobile phone 3 shown in FIG. 1 perform communication based on a TDMA system or TDMA/TDD transfer system that conforms to the RCR STD-27 and the RCR STD-28 formulated by ARIB (Association of Radio Industries and Business of Japan). In the communication transfer, voice call and data communication are performed at a transfer speed of 32 kb/s to time-slot or at a transfer speed of (32 kb/s×2=64 kb/s) to two time-slots. The mobile phone 3 moves into a service area of the cell base station 2a and, then, a control channel (CCH) is scanned and monitored and the control channel of a maximum received signal strength indicator is complemented. After registering the position, a communication sequence of a well-known call (transmission) or incoming (reception) is executed.

The fundamental operations of the components in FIGS. 1 and 2 are mentioned above.

Next, a description is given of a business method and its data processing in tile case of embodying “email transmission/direct marketing research in accordance with attribute information in the present invention”.

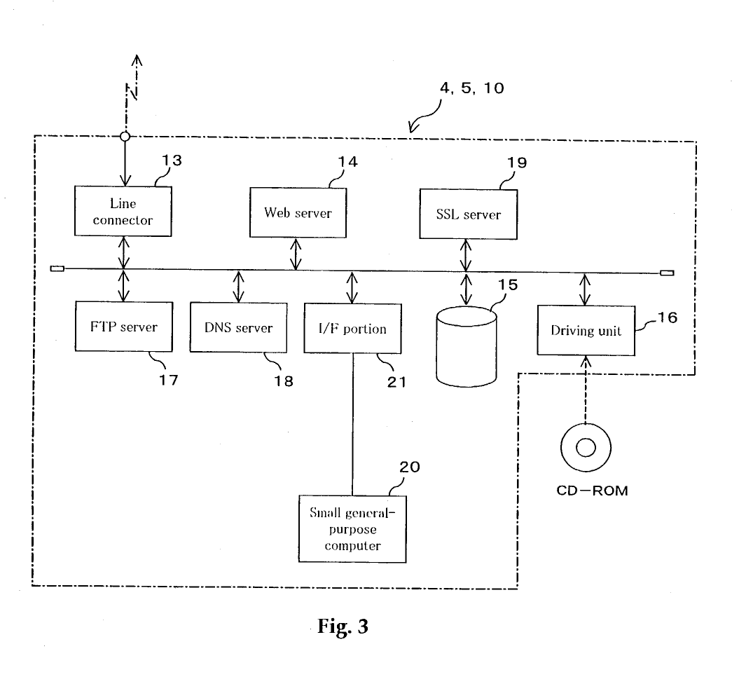

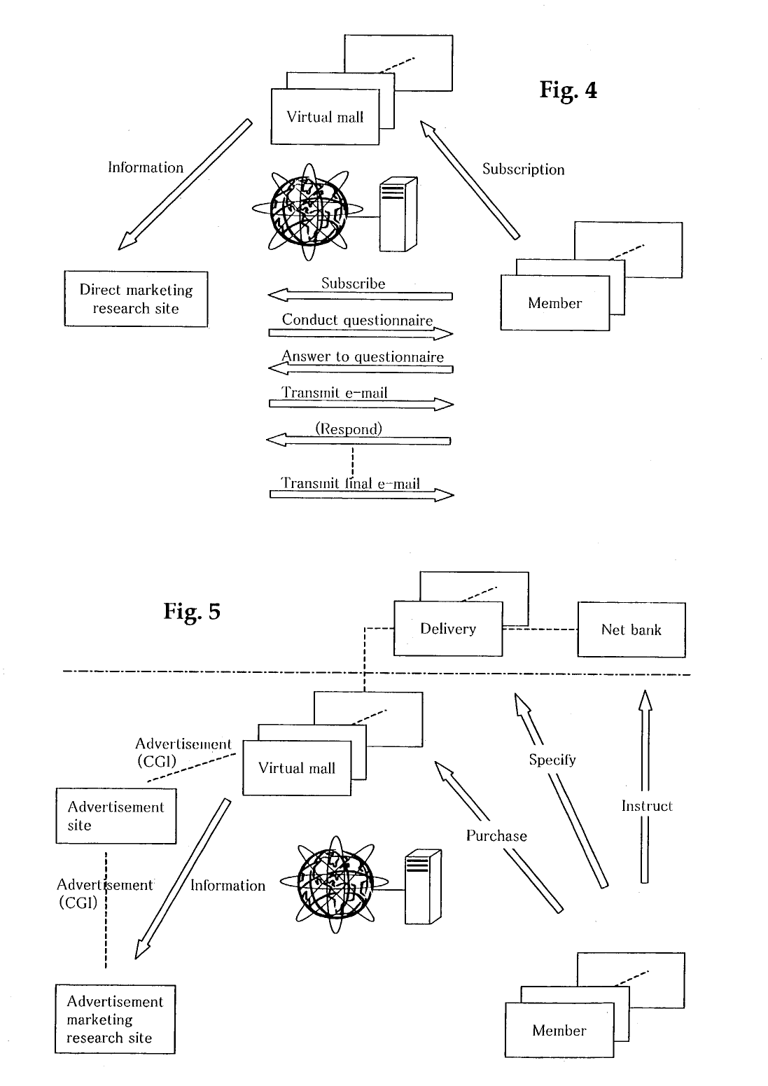

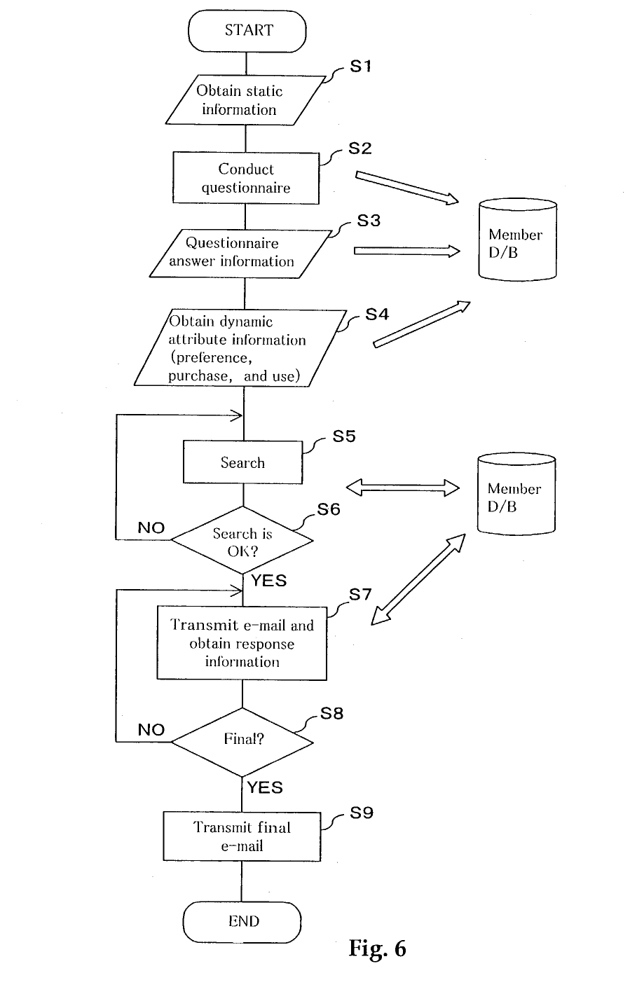

FIG. 4 is a diagram for explaining one business method in the case of embodying “email transmission/direct marketing in accordance with attribute information in the present invention”, FIG. 5 is a diagram for explaining another business method in the case of embodying “email transmission/direct marketing in accordance with attribute information in the present invention”, and FIG. 6 is a diagram showing a processing sequence of the information transmitting site communication system 4. The business method and the data processing are described in detail based on the processing sequence shown in FIG. 6.

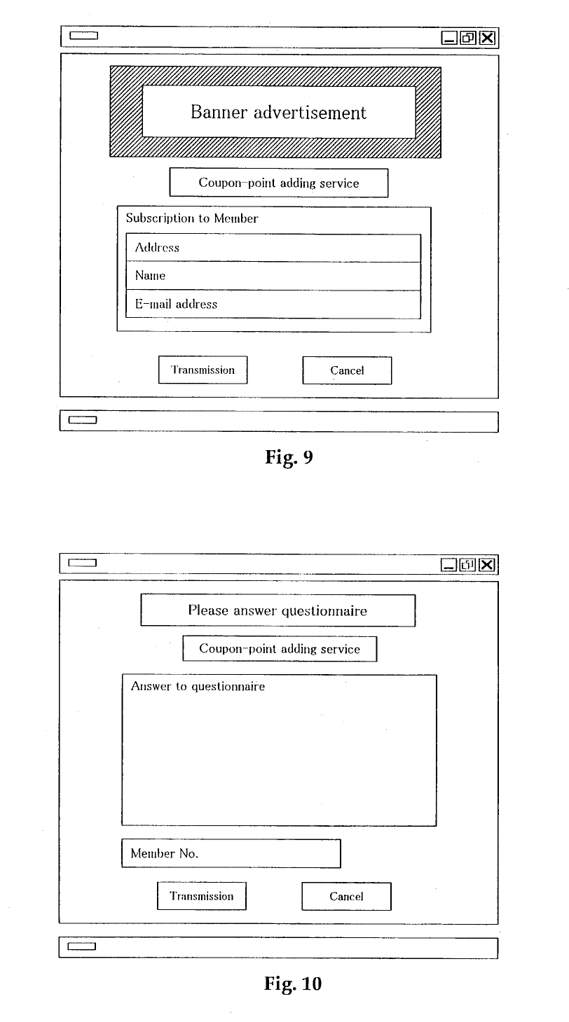

Referring to FIG. 4, according to the business method on an information transmitting site (information transmitting site communication system 4), the member (the small general-purpose computer 6) subscribes to a member of the virtual mall (virtual mall network Vsn) via a CGI link or document on the Internet. In this case, a display screen on the information transmitting site via the Internet is shown in FIG. 9, which will be described later.

Incidentally, the subscription to the member may be performed on the information transmitting site, directly via the Internet (step S1 in FIG. 6). Any information may be used for the subscription to the member and, for example, information obtained via telephone voice guide and information based on a document sent by post may be used. Accordingly, the information is stored in the database as digital data.

The member's attribute information in the subscription to the member is, e.g., only static attribute information in the private/social/individual information. For instance, the member attribute information includes an address, a name, a telephone number, and an email address. Efficient information transmission needs the increase in the number of subscribers. The number of items for registration upon subscription is decreased as much as possible to increase the number of subscribers. Incidentally, the email address is necessary for conducting a later questionnaire and direct mailing via the email and, must be described. If the information transmitting site can present services such as a free personal web email, the email address is not necessarily described.

In the subscription, a member number is automatically assigned every member and subsequent processing is executed based on the member number. Incidentally, the email address may be used as the member number and, alternatively, an identification code (ID) or a password may be assigned and commercial products can be purchased in the virtual mall. Therefore, the security of the data processing upon purchasing the commercial products can be guaranteed.

Further, the subscription to the member is effectively induced by adding points for discount and coupon upon purchasing the commercial products in the virtual mall (virtual mall network Vsn).

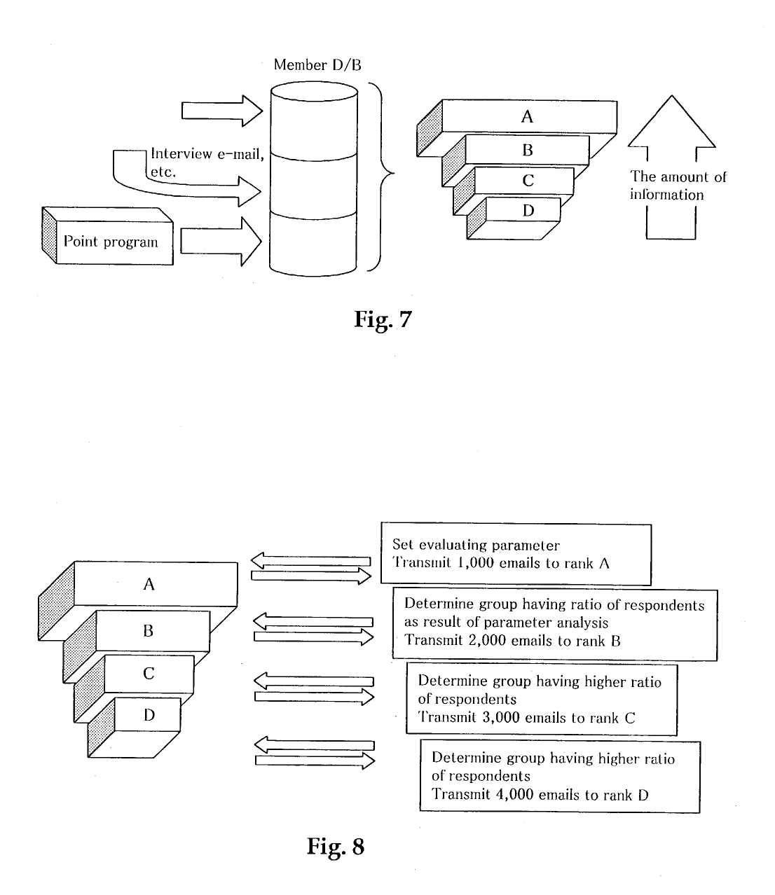

On the information transmitting site, the information on the subscription to the member in the virtual mall is stored in the database device 15 shown in FIG. 3. The static attribute information stored in the database device 15 is stored as will be described later with reference to FIG. 7. Then, the dynamic attribute information, e.g., attribute information on the preference, the purchase, and the use is added.

As shown in FIG. 4, after the member registration, occasionally, the dynamic attribute information (information on each member such as the preference, a desire of purchasing the commercial products, a plan concerning the use for services) from answers obtained by a questionnaire which is performed for the member, with venefitn, and a simple interview upon purchasing is extracted, and is stored in the database device 15 every member (steps S2 and S3).

As shown in FIG. 5, the dynamic attribute information on each member upon purchasing in the virtual mall is collected. In this case, as the dynamic attribute information, contents of member's payment via net bank, etc. are collected. For example, there are dynamic attribute information on a payment state of each member, such as the use of a debit card or a credit card (including the number of use time, the amount of money, and a credit card company used) and dynamic attribute information on the change on payment capacity.

As the dynamic attribute information on each member upon purchasing the commercial products in the virtual mall, delivery information is collected. For example, the delivery information includes information on specifying one of a plurality of delivery companies and information on specified time. As a consequence, the dynamic attribute information such as a favorite home delivery company and at-home time is collected(step S4).

On the information transmitting site and on its link site, an advertisement banner and click information at the link destination are recorded and, further, a day of the week and time upon click are recoded. The dynamic attribute information about in which information the member is interested and how an access environment is is recorded.

Moreover, various information is provided via the email transmitted to the member. The respective information is provided on the web by clicking the link destination to which a character identification code is marked. Click time of the information and click frequency are recorded. The above information is recorded as preference information. Obviously, the transmitted email is not limited to a text format and may be in the HTML format. A link banner prepared for the HTML format may include a still image and a moving image.

The dynamic attribute information is transferred to the information transmitting site from the virtual mall and is stored in the database device 15 every member. That is, the member's dynamic attribute information is added and stored in the static attribute information upon the subscription to the member. Incidentally, the static attribute information upon the subscription to the member and the dynamic attribute information are updated and, alternatively, added data of the static attribute information upon the subscription to the member and the dynamic attribute information are processed.

The member can freely check the static attribute information which is registered by himself/herself, on the screen of the information transmitting site, at any time. If there is an error and an update of the static attribute information, the member can correct them at any time. If there is related information, the member can occasionally display the related information and it is capable of devising a way to always drawing member's attention to the change. For example, when the address must be checked in the case of sending a gift and delivering a purchased commercial product, the registered address is displayed and it is checked whether or not the address is changed.

More specifically, when the address change and the update of the age are informed from the member, the data in the database device 15 is updated. For example, as mentioned above, when information on the credit card company and the at-home time is changed, the data is updated. Incidentally, information which did not be registered is added.

As described above, the static attribute information and the dynamic attribute information are stored every member. Alter that, the database for member on the information transmitting site is segmented into ranks (information ranks) based on the amount of the static attribute information and the dynamic attribute information for each member, as will be shown later in FIG. 8.

FIG. 7 is a diagram for explaining ranking based on the amount of the static attribute information and the dynamic attribute information for the member. Referring to FIG. 7, the database device 15 for the member on the information transmitting site stores the minimum amount of the static attribute information upon the subscription to the member, information in the questionnaire to the members, and the dynamic attribute information upon purchasing a used product in the virtual mall. Further, the database device 15 updates the registered static and dynamic attribute information to be the latest static and dynamic attribute information which is added and stored. Incidentally, the static and dynamic attribute information for each member is segmented into A-, B-, C-, and D-ranks based on the amount of the static and dynamic attribute information.

On the information transmitting site, information is collected by preparing gifts and games so that the members answer the questionnaire and the like to improve the information ranks. As a consequence, the ranks are increased.

When there is a “company desired to be transmitted” is widely advertised via the email, first, related items are determined on the information transmitting site based on the transmitted information and contents of expected response. For instance, the transmitted information corresponds to an introduction of a new-color lip stick using a new case for female, and the expected response corresponds to access to a site on which the lip stick is described in detail. If the number of emails which is scheduled to be transmitted is 100,000, sex, age, occupation, annual income, favorite sports, single/married, interest in cosmetics, degree of infatuation with big-name brands, favorite degree of a new commercial product, etc. are selected from the items stored in the database. Obviously, all the items may be used without limiting the items.

Next, 5,000 emails are transmitted to the top A-information-ranked members at random. Obviously, a marketer may extract the members at some degree to improve the efficiency. The returned email includes a link to the web page which represents detail information and a character link whereby it can be known which member clicks the link.

After a predetermined time of period, the responses of the stored emails, which are first transmitted, are analyzed. Obviously, there are responsive members and non-responsive members. However, points are added to the above-selected items in the attribute of the responsive members. The item, which is greatly correlative to the response is determined.

Next, the email is transmitted to the second information rank B. The transmission target is the member having information that matches the item greatly correlative to the response, which is obtained at the rank A as the top rank. However, the information rank falls down and, therefore, the information corresponding to the item cannot be certainly obtained. Then, a group of members having information which matches other item conditions are searched to obtain the large number of members having information which matches the other items. For example, it is assumed that data of type of occupation is not sufficiently obtained at the second rank, when a single female at management post of service businesses greatly responds to any desired item. Another item which is greatly correlative to the response is searched by using a data mining method. If there is a high correlation between the females at the management post of the service businesses and a ratio of respondents of the questionnaire of a uniform design for female clerks, 5,000 emails are selected from the single females at the management post of the services and the single females who answered the questionnaire of the uniform design for the female clerks at the previous time, and are transmitted.

These operations are repeated while descending the ranks until the number of transmitted emails reaches a planned one.

Although, obviously, these operations can manually be performed by utilizing marketer's experience and acknowledgement, they can automatically be performed by utilizing a computer as long as the data mining method is established.

As mentioned above, the static attribute information and the dynamic attribute information for each member are collected. Alter that, the items are searched based on the amount of the information (rank) including the static attribute information and the dynamic attribute information for each member (steps S5 and S6). Email information (e.g., a questionnaire corresponding to the direct mailing on an advertiser (advertiser communication system 9)) is transmitted and the transmission target of the email information is sequentially narrowed down based on the response upon the occurrence of an event of the member (occurrence of the dynamic attribute information) and tile members having information which rightly matches the contents of the email information (direct email) are finally narrowed down and selected (steps S7, S8, and S9).

Next, a description is given of the specific method for ranking the attribute information and transmitting the email.

FIG. 8 is a diagram for explaining the specific method for transmitting the email.

Referring to FIG. 8, in the specific example of transmitting the email, the members having the information which rightly matches the contents of the email information (direct email) are finally narrowed down and selected by transmitting the emails corresponding to the ranks A, B, C, and D four times.

The information used for transmitting the email is, e.g., a questionnaire of the commercial product. The members having information which rightly matches the commercial product are narrowed down and selected based on questions to the members, concerning the preference of the commercial product (individual attribute information) and the answer to the questions. The database device 15 executes this selection based on tracking by using a database engine. That is, the selecting process is automatically performed.

The narrowing down and selecting methods are shown in the following methods (1) to (4).

(1) The members of the “rank A” having the largest amount of the static attribute information and the dynamic attribute information, e.g., 1,000 members corresponding to 1,000 pieces of information are selected, and 1,000 pieces of the email information (herein, information on the commercial product questionnaire) are transmitted. The information transmitting site receives the member's answers to the commercial questionnaire. This operation corresponds to the conduct of the commercial product questionnaire with the lowest ratio of respondents.

(2) Further, the members of the “rank B” having the second largest amount of the static attribute information and the dynamic attribute information, 800 members corresponding to 800 pieces of the static attribute information and the dynamic attribute information are selected, and 2,000 pieces of the email information (herein, information on the commercial product questionnaire) are transmitted. The information transmitting site receives the member's answers to the commercial questionnaire. This operation corresponds to the conduct of the commercial product questionnaire with the second lowest ratio of respondents.

(3) The members of the “rank C” corresponding to the information (parameter) in the answers of the questionnaire in the method (2) are selected. For example, 600 members corresponding to 600 pieces of the static attribute information and the dynamic attribute information are selected, and 3,000 pieces of the email information (herein, information on the commercial product questionnaire) are transmitted. The information transmitting site receives the member's answers to the commercial questionnaire. This operation corresponds to the conduct of the commercial product questionnaire with the improved ratio of respondents.

(4) The members of the “rank D” corresponding to the information (parameter) in the answers of the questionnaire in the method (3) are selected. For example, 400 members corresponding to 400 pieces of the static attribute information and the dynamic attribute information are selected, and 4,000 pieces of the email information (herein, information on the commercial product questionnaire) are transmitted. The information transmitting site receives the member's answers to the commercial questionnaire. Through this operation, finally, the highest ratio of respondents is obtained by embodying the operation for narrowing down and selecting the best members four times.

Although the number of conducting times of the questionnaire by transmitting the emails is four, it can properly be updated. For example, the questionnaire may be conducted by transmitting the email information twice with the lower ratio of respondents. Further, the questionnaire may be conducted by transmitting the email information four or more times and the members can be narrowed down and selected with a high ratio of respondents. The number of conducting times of the questionnaire by transmitting the emails is determined based on selecting costs and a desire of a conducting person (advertiser communication system 9) that transmits the direct email based on the selection.

Next, a description is given of a main display screen according to the specific method for ranking the attribute information and transmitting the email.

FIG. 9 is a diagram showing a display screen in the case of collecting the dynamic attribute information via the procedure of the subscription to the member on the Internet.

Referring to FIG. 9, on the display screen for the procedure of the subscription to tile member, advertisements of the company (advertiser communication system 9) and the shop (shop-keeper's computer 8) are inserted. In this case, there is an excessively small amount of the described information including the static attribute information and the dynamic attribute information for each member, as mentioned above. For instance, only an email address may be included in the described information, though in extreme view. The display screen indicates to add the coupon point available for the virtual mall network Vsn. The static attribute information is obtained from the described contents upon the subscription.

FIG. 10 is a diagram showing a display screen in the case of collecting the dynamic attribute information through the questionnaire to the members on the information transmitting site.

Referring to FIG. 10, the display screen for tile questionnaire indicates the contents of the questionnaire and the addition of the coupon point for the questionnaire answer, available for the virtual mall network Vsn. The dynamic attribute information is obtained from the questionnaire answers.

It is determined that a fact of no answer means that the members are not interested in the above questionnaire. By canceling the conduct of the questionnaire to the no-answer members, the marketing efficiency is improved. Further, an advertisement with a plurality of quizzes having different number of coupon points is conducted, thereby obtaining the dynamic attribute information in which each member is interested, corresponding to the number of coupon points. In other words, only the email information including the advertisement with the quiz having a larger number of coupon points may be transmitted to the members who respond only to the advertisement with the quiz having the large number of coupon points.

FIG. 11 is a diagram showing a display screen in the case of collecting the dynamic attribute information upon purchasing the commercial product in the virtual mall.

Referring to FIG. 11, on the display screen upon purchasing the commercial product, a photograph and a description thereof a unit price, etc. are described to a catalog. The member selects and describes an article code from the catalog to purchase the commercial product. The member also selects a delivery method and a method of remittance. The dynamic attribute information is also obtained upon purchasing the commercial product. For instance, it is possible to obtain the dynamic attribute information of the member who purchases only a specific commercial product in seasonal commercial products. Although, obviously, the process for actually purchasing the commercial product is effective, a virtual experience might be effective to means for obtaining the preference information, rather than the actual purchase. Services for presenting a chance of the virtual experience such as games for stock trading, which are actually played in recent years, are increased.

In the selection of the delivery method, the member's at-home time is determined based on the specification of the at-home time. For instance, the possibility to view the direct email is increased by transferring the direct email at holiday. Based on a state of selecting the method of remittance, e.g., a state change from the selection of the debit card to the selection of the credit card, the dynamic attribute information on the periodic change of the member's economic capacity is obtained. The marketing efficiency is improved by transmitting the direct email corresponding to the obtained information.

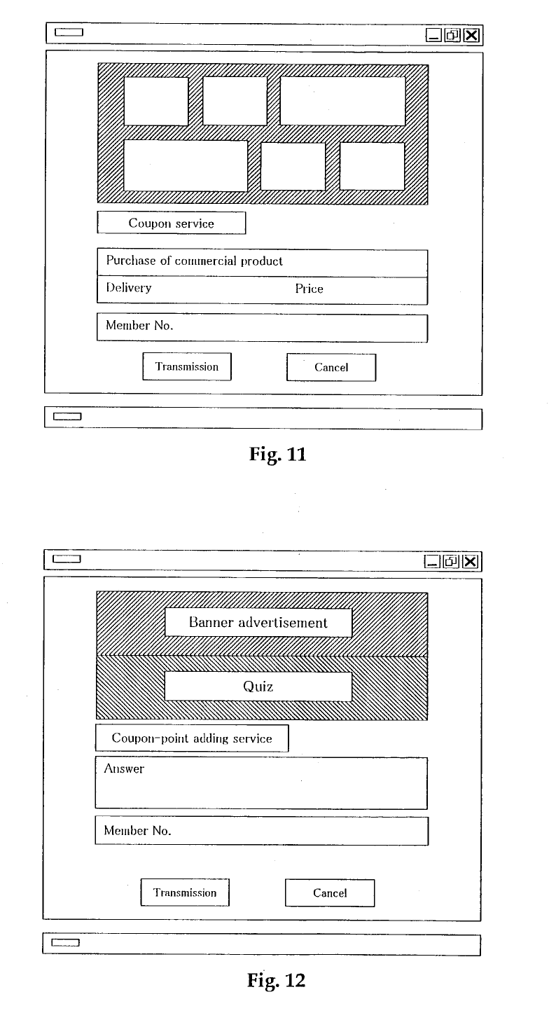

FIG. 12 is a diagram showing a display screen in the case of collecting the dynamic attribute information through a banner advertisement with the quiz on the information transmitting site.

Referring to FIG. 12, in the banner advertisement with the quiz, a banner advertisement (not shown) and a quiz are represented. The member answers the quiz. The coupon point is added to the members based on the answer. The dynamic attribute information for each member is obtained from the answer level of the quiz answer.

The result of no answer enables the members who are not interested in the above quiz to be narrowed down and selected. The dynamic attribute information is obtained to prevent the sequent transmission of the direct email.

Advantageously, the marketing can be executed to restart the presentation of the quiz to the members and to obtain the dynamic attribute information for the member who responds to the advertisement with a specific quiz.

Although the present embodiment is described by using the small general-purpose computer 6 as the device used by the member, the use of the mobile phone 3 having a web browser enables “email transmission/direct marketing research in accordance with attribute information in the present invention” to be embodied.

The display screen of the mobile phone 3 is relatively small and, therefore, the editing server 7 in FIG. 1 needs to edit again the contents on the display screen so that the display contents match the size corresponding to the display screen or a scroll operation.

According to another method using the mobile phone 3 having a web site capable of singly implementing an Internet surfing, “email transmission/direct marketing research in accordance with attribute information in the present invention” can be embodied. For example, when a mobile computer having a web browser capable of the Internet surfing is connected to a mobile telephone having no web browser, the above-mentioned operation can be effected. Also, when a small image display device is connected to the mobile telephone by using a Blue tooth system (based on IEEE standard) via a radio interface, the above-mentioned operation can be effected.

According to the present embodiment, a transfer screen (file) from the information transmitting site (information transmitting site communication system 4) starts the SSL server 17 when necessary. Transfer for encryption is executed to keep secret, thus preventing the leak of the contents. For instance, the leak of the described items for obtaining the private attribute information is prevented. The security of the remittance is kept.

Although the present embodiment is described by applying the open Internet, “email transmission/direct marketing research in accordance with attribute information in the present invention” can be embodied by applying a closed communication network which is open only to related business communities and associations. For instance, “email transmission/direct marketing research in accordance with attribute information in the present invention” can be embodied by applying Intranet. Further, “email transmission/direct marketing research in accordance with attribute information in the present invention” can be embodied in the international world by applying an extranet which internationally connects the Internet which is domestically structured. That is, it is possible to embody “email transmission/direct marketing research in accordance with attribute information in the present invention” in consideration of the nationality and the locality in the international world.

Although the payment is performed via the net bank according to the present embodiment, the present invention can be applied to usual inter-bank foreign-currency remittance without using the net bank.

### INDUSTRIAL APPLICABILITY

In the email transmitting method using the computer interactive communication network, the communication system of the email transmitting method, and the information recording medium according to the present invention, the members are narrowed down by transmitting a plurality of pieces of information and, thus, the members having information that rightly matches the contents of the email information are narrowed down and selected. As a consequence, the direct emails can be transmitted to the transmission targets having the rightly matching attribute information (private/social/individual attribute), in the information to be transmitted, and the high-level direct marketing can effectively be performed with saved labor.

1. An email transmitting method using a computer interactive communication network, for direct marketing research by obtaining and managing attribute information, comprising the steps of:
repeatedly collecting static attribute information, of members, including an email address;
repeatedly collecting dynamic attribute information including individual information of said member;
updating or adding said member's static attribute information and dynamic attribute information which are repeatedly collected;
evaluating a correlation among information to be presented to the member and the stored static attribute information and dynamic attribute information; and
extracting the member having the high correlation evaluated.

2. An email transmitting method using a computer interactive communication network according to claim 1, wherein a function for updating or adding the dynamic attribute information by setting a response to contents of the email received to the member, to be new dynamic attribute information is provided, when the email is transmitted.

3. An email transmitting method using a computer interactive communication network according to claim 1 or 2, further comprising the steps of:
when said email information is transmitted,
ranking said stored static attribute information and dynamic attribute information of the member based on the amount of said stored static and dynamic attribute information;
transmitting the email information to the member having the maximum amount of the static attribute information and the dynamic attribute information which are ranked based on the amount of said stored static and dynamic attribute information;
transmitting the email information by extracting response information to said transmission of the email information, from the member, and further extracting the member having the static attribute information and the dynamic attribute information which match the response information; and
narrowing down and selecting the member having information that matches the email information having specific contents by transmitting the email information at least twice.

4. An email transmitting method using a computer interactive communication network according to any one of claims 1 to 3, wherein when the email is transmitted, the email information is transmitted, at first time, to the member having the largest amount of the static attribute information and the dynamic attribute information, and the email information is transmitted, at second time, to the member having the second largest amount of the static attribute information and the dynamic attribute information or the email information is transmitted, at second time or subsequent time thereto, to the member having the sequentially reduced number of the static attribute information and the dynamic attribute information.

5. An email transmitting method using a computer interactive communication network according to any one of claims 1 to 4, wherein a point for discount when purchasing a commercial product in a virtual mall or at a general shop and/or a point for offering a coupon is added to the members upon said subscription to the member, and is allowed to be used,
data on said addition and use of the point for coupon is collected, and
the collected data is new dynamic attribute information, and the dynamic attribute information is updated or added.

6. An email transmitting method using a computer interactive communication network according to any one of claims 1 to 5, wherein said dynamic attribute information is at least one of:
(a) answer information including preference of the commercial product when a questionnaire is executed to the members;
(b) purchase information of each member, including selection of the commercial product in the virtual mall;
(c) delivery instruction information of each member, including delivery time of a purchased commercial product in the virtual mall;
(d) payment information of each member, including payment, via net bank, of the commercial product purchased in the virtual mall; and
(e) action information of each member, including the number, the time, and the frequency of clicking a specific link or banner on a related web site.

7. A direct marketing communication system for an email transmitting communication system, using a computer interactive communication network, by obtaining and managing attribute information, comprising:
member communication means which inputs and transfers static attribute information of each member, including an email address, transfers an answer to a questionnaire, and executes communication for purchasing a commercial product in a virtual mall;
virtual mall communication means which executes communication for transferring information on purchase of the commercial product and information on the use of additional services such as a reward card through adding points, when the commercial product is purchase by said member communication means in the virtual mall; and
email transmitting communication means which executes communication for repeatedly collecting the static attribute information from said member communication means, dynamic attribute information on the answer to the questionnaire, and information of each member, on the purchase of the commercial product, from said virtual mall communication means, updating or adding them, and storing them, for ranking the members in accordance with the amount of the stored information and transmitting email information to the member having the largest amount of the static attribute information and the dynamic attribute information which are ranked, for extracting response information from the member, further extracting the member having the static attribute information and the dynamic attribute information which match the response information, and transmitting the email information to the extracted members, and for narrowing down and selecting the members having information which rightly matches the email information with specific contents by transmitting the email information at least twice.

8. A direct marketing communication system according to claim 7, wherein said computer communication means comprises:
a mobile phone to which an application for interactive communication is implemented, or
a mobile phone to which said application is not implemented and a small general-purpose computer to which said application connected to the mobile phone is implemented.
